(19) United States
(12) Patent Application Publication
(10) Pub. No.: US 2011/0088100 A1
(43) Pub. Date: Apr. 14, 2011

(54) DISABLING ELECTRONIC DISPLAY DEVICES

(76) Inventor: Serge RUTMAN, Boulder Creek, CA (US)

(21) Appl. No.: 12/578,972

(22) Filed: Oct. 14, 2009

(51) Int. Cl. G06F 21/00

(52) U.S. Cl. 726/28

(57) ABSTRACT

A system for and method of management of electronic content access are disclosed. The system and method provide for managing electronic content access including detecting, at an electronic paper display device, an event requiring electronic content access management. According to some embodiments, access may be disabled to one or more portions of electronic content for a user of the electronic paper display device based at least in part on the detection of an event requiring electronic content access management. In one or more embodiments, a notification may be sent to a user of an electronic paper display device based at least in part on the detection of an event requiring electronic content access management.

### FIELD OF THE INVENTION

The present invention generally relates to a system for and method of managing access to electronic content via an electronic display device.

### BRIEF DESCRIPTION OF THE DRAWINGS

The present invention, together with further objects and advantages, may best be understood by reference to the following description taken in conjunction with the accompanying drawings, in the several figures of which like reference numerals identify like elements, and in which:

FIG. 1 is a schematic diagram of a system for managing electronic content according to an embodiment of the present invention;

FIG. 2 is a flow chart illustrating a method for managing electronic content according to an embodiment of the present invention;

FIG. 3A is a schematic diagram of an electronic display device according to an embodiment of the present invention;

FIG. 3B is a schematic diagram of an electronic display device according to an alternate embodiment of the present invention; and

FIG. 4 is a schematic diagram of a power supply path for an electronic display device according to an embodiment of the present invention.

### DETAILED DESCRIPTION OF EMBODIMENTS

Certain embodiments of the present invention provide electronic content access management on an electronic display device. More particularly, certain embodiments of the present invention provide a system for and method of managing electronic content access. Such electronic content may be accessed, by way of non-limiting example, via a device utilizing an electronic paper display (referred to herein as “EPD”), such as electrophoretic displays or electro-wetting displays. Other embodiments may use an LCD (Liquid Crystal Display) based display, an LEP (Light Emitting Polymer) based display, a OLED (Organic Light Emitting Diode) based display, or other display technologies.

Management of electronic content may include not only producing, formatting, aggregating, and distributing electronic content, but also management of subscription accounts to electronic content and enforcement of account rules. Enforcement of account rules may include any, or a combination, of detection of copyright violation, prevention of copyright violation, detection of account usage violations, prevention of account usage violations, detection of access violations, prevention of access violations, digital rights management functionality, notifications, account management, monitoring of contractual agreements, enforcement of contractual agreements, monitoring of other regulations, and enforcement of other regulations.

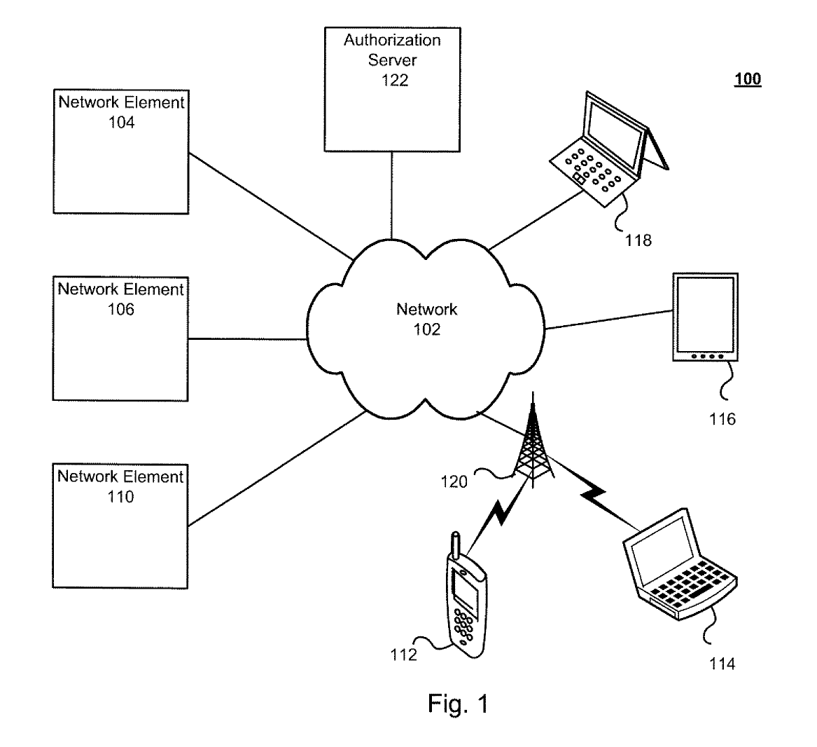

FIG. 1 is a schematic diagram of a system 100 for managing access to electronic content according to an embodiment of the present invention. FIG. 1 is a simplified view of system 100, which may include additional elements that are not depicted. Network elements 104, 106, and 110 may be servers, network storage devices or other devices communicatively coupled to network 102. Any, or a combination, of electronic display devices 112, 114, 116, and 118 may be communicatively coupled to network 102. Authorization server 122 may also be communicatively coupled to network 102. As illustrated in FIG. 1, one or more electronic display devices may connect to network 102 via a wireless access point such as wireless access point 120. In one or more embodiments, an electronic display device, such as electronic display device 116, may not be connected to a network. According to one or more embodiments, an electronic display device may receive electronic content and data via user input, data storage devices (e.g., flash memory cards, Compact Disk (CD) drives, Digital Video Disk (DVD) drives, tape drives, and external hard drives) or other device interfaces.

Network 102 may be a local area network (LAN), a wide area network (WAN), the Internet, a cellular network, a satellite network, or another network that permits communication between network elements 104, 106, and 110, electronic display devices 112, 114, 116, and 118, and other devices communicatively coupled to network 102. In one or more embodiments, network 102 may be an electronic content distribution network. Such exemplary content distribution networks are disclosed in U.S. application Ser. No. 12/248,482, titled “Systems, Methods and Apparatus for Content Distribution,” filed on Oct. 9, 2008 and U.S. provisional application No. 60/978,748, titled “Content Distribution and Preloading,” which was filed on Oct. 9, 2007; the content of both applications is hereby incorporated by reference in their entirety.

Authorization server 122 may use Digital Rights Management (DRM), encryption, and conditional access technologies to validate and regulate access to electronic content. By way of non-limiting example, authorization server 122 may implement a conditional access system such as a system available from NDS Group, LTD. of Staines, United Kingdom. Authorization server 122 may communicate securely with a conditional access module and a decryption smart card or circuit associated with an electronic display device.

Network elements 104, 106, and 110 may be servers, network storage devices or other devices communicatively coupled to network 102. In one or more embodiments, network elements 104, 106, and 110 may perform any, or a combination, of storing, receiving, transmitting, producing, and aggregating electronic content. Network elements 104, 106, and 110 may also perform other electronic content management functionality including, but not limited to, any, or a combination, of account management, account usage monitoring, and content distribution.

Network elements 104, 106, and 110 may contain or be communicatively coupled to storage, such as a redundant array of inexpensive disks (RAID), a storage area network (SAN), an internet small computer systems interface (iSCSI) SAN, a Fibre Channel SAN, a common Internet File System (CIFS), network attached storage (NAS), a network file system (NFS), tape drive based storage, or other computer accessible storage.

Network elements 104, 106, and 110 communicate with any, or a combination, of other systems, applications, and storage locations directly via one or more of an Application Programming Interface (API), a Remote Procedure Call (RPC), an interface tables, a web service, Extensible Markup Language (XML) based interfaces, Simple Object Access Protocol (SOAP) based interfaces, common request broker architecture (CORBA) based interfaces, and other interfaces for sending or receiving information. For example, network elements 104, 106, and 110 may communicate with accounting systems, authentication systems, systems of content providers, or other systems, servers, or components to facilitate electronic content management.

Network elements 104, 106, and 110 may each be responsible for different functionality in an electronic content distribution network. By way of non-limiting example, network element 104 may produce, receive, retrieve, or aggregate electronic content, such as periodicals, books, newsletters, or other electronic content. Such electronic content may be aggregated from one or more feeds, such as publishers, resellers, newspapers, journalists, news services, broadcasts, or other sources. Processing of electronic content may include any, or a combination, of indexing, categorizing, storing, formatting, translating, filtering, spell checking, compressing, encrypting, securing, replicating, and further processing. Electronic content may be produced by user input (e.g., blogs, newsletters, etc.) such as by way of non-limiting example, typed input or dictations processed by speech to text input (e.g., text of speeches, conferences, proceedings, hearings, etc.). Electronic content may be produced by scanning existing text, such as by way of non-limiting example, by Optical Character Recognition (OCR) processes. Other scanning processes may produce electronic content without performing OCR processes. Network element 104 may translate content from one format to another. For example, network element 104 may receive content from a subscriber and may translate the content into one or more electronic formats including, but not limited to, proprietary formats utilized by one or more e-book readers. Network element 104 may receive subscriber or user content via emails, FTP (File Transfer Protocol), HTTP (Hyper Text Transfer Protocol), text message (e.g., via Short Message Service (SMS)), Multi-Media Messaging Service (MMS), Wireless Access Protocol (WAP), or via other electronic communication protocols. Categorization of content by network element 104 may include any, or a combination, of organizing content, storing content, and indexing content by one or more of a subject, subscription and access. By way of non-limiting example, content may be grouped or stored in databases or other storage which may be separated according to subscription.

By way of non-limiting example, network element 106 may perform one or more account management functionalities. For example, network element 106 may contain and access any, or a combination of user subscription information, accounting information, security information, blacklist information, whitelist information, or other information indicating user identification, account identification, and user access to one or more portions of electronic content. Network element 106 may interface to other systems or components, either local or remote, such as accounting systems, Customer Relationship Management (CRM) systems, marketing systems, payment systems, authentication systems, network access servers, Remote Authentication Dial In User Service (RADIUS) based systems, proxy servers, firewalls, or other network systems or components. Network element 106 monitor one or more accounts and may monitor access to electronic content stored on, distributed by, or accessible from network 102 or one or more devices communicatively coupled to network 102.

Network element 106 may generate and send one or more notifications, reports, emails, or other electronic messages to one or more users. Notifications may be encrypted or otherwise securely transmitted. Notifications may be one or more data transmissions that result in an end user device, such as an e-book reader, displaying a message on a display associated with the end-user device. Notifications may be warnings, marketing communications, termination notices, or other communications. Warning notifications may be sent to one or more users and the warning notifications may be associated with any, or a combination, of subjects including amounts due or overdue, account usage violations, account access violations, account usage guidelines, copyright violations, impermissible software installation, impermissible device software modification, impermissible device hardware modification, content expiration dates, or other account, content, and e-book reader usage violations or suspected violations. Network element 106 may send different levels of warnings or different types of notifications based on an event prompting the warning and whether the event is suspected or confirmed. In one or more embodiments, network element 106 may allow or trigger the generation of notifications sent via postal mail, such as for example, account termination notices.

According to one or more embodiments, network element 106 may send notifications enabling payment, subscription renewal, account access, or other account information. By way of non-limiting example, network element 106 may send a notification regarding an account payment which may contain a URL (Uniform Resource Link) or other information to access a payment system.

In one or more embodiments, network element 106 may interface with one or more of network element 110, an end user device, and another network component, in order to perform one or more electronic content management actions. Network element 110 may, by way of non-limiting example, control distribution of electronic content. Network element 110 may permit or deny access to one or more components of an electronic content distribution network, such as network 102 and network element 104. Network element 110 may stop one or more feeds or electronic data transmissions to one or more end-user devices. Network element 110 may deny access to one or more users for one or more portions of an electronic content servers, a database or other electronic content associated with network 102. Network element 110 may use one or more mechanisms to control access to content, including but not limited to, Access Control Lists (ACLs), roles, authentication, usernames and passwords, digital signatures, cryptographic keys, or other mechanisms. For example, network element 110 may change a setting or a flag expiring specified credentials or freezing access for specified credentials.

In addition to controlling access to one or more components of an electronic content distribution network, network element 110 may control access within a component, such as a server, according to some embodiments. Network element 110 may control access in a granular manner, such as by way of non-limiting example, restricting access to certain portions of content or to portions of one or more content distribution networks or feeds for one or more users. Network element 110 may restrict access to a group for one or more portions of content. By way of non-limiting example, a corporation may provide access to one or portions of content, such as periodical subscriptions, for a group of their employees. Upon expiration of one of the subscriptions, network element 106, or another electronic content distribution management component, may interface with network element 110 to restrict access for the group to the expired subscription. Network element 110, or another electronic content distribution management component, may modify a role, modify an ACL, expire a certificate, set a flag, or provide an indicator restricting access or preventing feeds of or access to the expired content for the group. The group in this example may continue to access other separately subscribed content, free content, or other functionality. In other embodiments, the group may be denied access to one or more portions of content and functionality. Continuing this example, if the corporation allows the expired subscription to be renewed, network element 110 may take one or more actions to allow access or resume feeds to the re-subscribed content. In one or more embodiments, group subscriptions may be controlled with further controls providing additional granularity in electronic content access management. For example, if a corporation subscribes to electronic content for a group of employees, access violations may be addressed individually. If one of the corporate employees in this example attempts to perform an unauthorized action, such as impermissibly copying electronic content, network element 110 may deny access to one or more portions of electronic content for that user without affecting the access of the rest of the group. According to one or more embodiments, impermissible copies may be detected by the presence of one or more electronic content files not containing one or more of a digital signature, a checksum, a hash value, a digital watermark, metadata, a steganographic verification code, or other electronic content verification mechanisms. The additional electronic content control granularity excluding one or more individual members of a group may be provided by modifying a group role, a group ACL, by further filtering access using a blacklist, by limiting functionality of a specified end user device, or by other mechanisms.

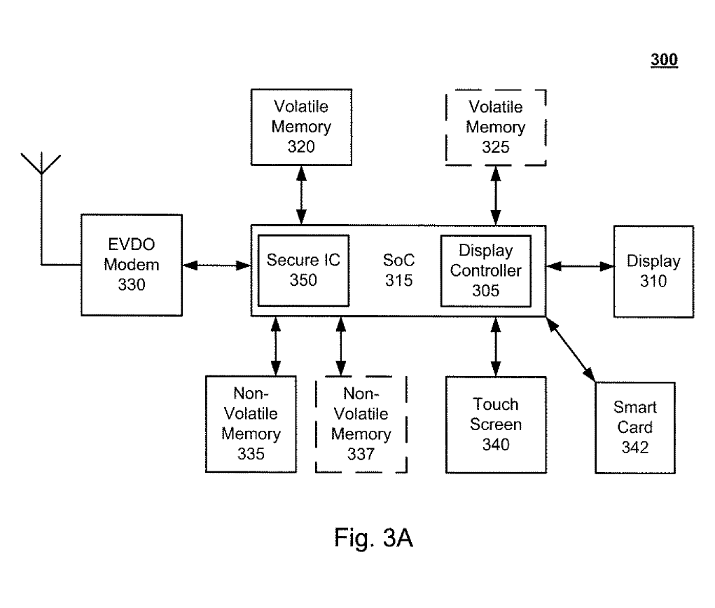

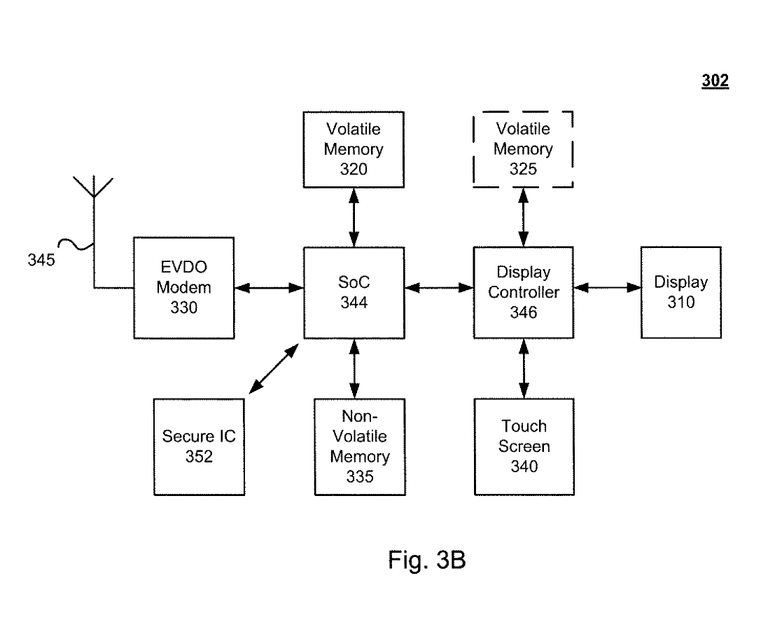

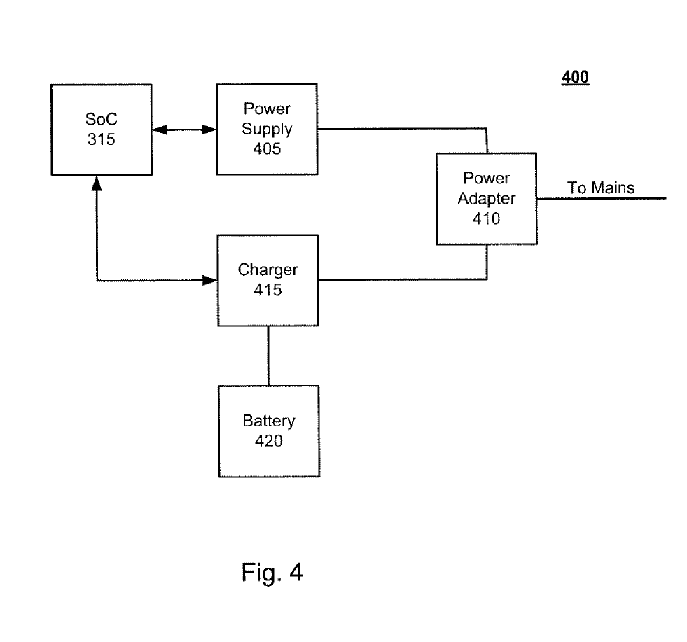

According to one or more embodiments, network element 110 may transmit data to one or more end user devices, such as electronic display devices 112, 114, 116, and 118, which may restrict or prevent user access to functionality. As described in greater detail with reference to FIGS. 3 and 4 below, one or more components of a content distribution network, such as network element 110, may prevent access of an end user device to an electronic content distribution network or to electronic content locally stored or locally accessed by an end user device. For example, network element 110 may transmit data to one or more end user devices and the end user devices may prevent access to one or more portions of device functionality.

Network element 110, and other components of a content distribution network, may receive data from an electronic display device indicating detection of an access or usage violation, expiration of content, or another event. For example, an electronic display device may contain credentials utilized for decryption of electronic content. An electronic device may detect the expiration of the credentials. In another example, an electronic device may detect unauthorized installation of software or modification of existing software. The end user device may transmit data notifying one or more components of an electronic content distribution network. In response, network element 110 may restrict access to one or more portions of electronic content. Alternatively or in addition, network element 110 may transmit data to one or more electronic display devices causing the devices to disable one or more portions of functionality, restrict access to locally stored or locally accessed content, or discard locally stored content. In one or more embodiments, upon detecting an access violation, usage violation, or other event, an electronic display device may disable one or more portions of functionality of the device and restrict access to locally stored content and may not transmit data to the electronic content distribution network.

Electronic display devices 112, 114, 116, and 118 may be electronic book (e-book) readers, E-Ink® based devices, desktop computers, laptop computers, wireline phones, mobile phones, Personal Digital Assistants (PDA), personal media players, gaming devices, or other devices capable of displaying electronic content. In one or more embodiments, electronic display devices 112, 114, 116, and 118 may access electronic content locally via one or more device interfaces.

According to some embodiments, electronic display devices 112, 114, 116, and 118 may access electronic content via one or more network interfaces. Electronic display devices 112, 114, 116, and 118 may transmit and receive data to and from network 102 utilizing a standard telecommunications protocol or a standard networking protocol. By way of non-limiting example, one embodiment may utilize FTP (File Transfer Protocol), HTTP (Hyper Text Transfer Protocol), Wireless Application Protocol (WAP), Multimedia Messaging Service (MMS), Enhanced Messaging Service (EMS), Short Message Service (SMS), Global System for Mobile Communications (GSM) based systems, Transmission Control Protocol/Internet (TCP/IP) Protocols, or other protocols or systems suitable for transmitting and receiving electronic content data. Electronic content may be transmitted and received wirelessly or may utilize cabled network or telecom connections such as an Ethernet RJ45/Category 5 connection, a fiber connection, a traditional phone wireline connection, a cable connection or other wired network connection. Electronic display devices 112, 114, 116, and 118 may use standard wireless protocols including IEEE 802.11 and 802.16. Electronic display devices 112, 114, 116, and 118 may also be connected to network 102 via protocols for a wired connection, such as an IEEE Ethernet 802.3. In one or more embodiments, electronic content may be transmitted to another device, such as a computer of a user, and the user may then load the electronic content on an electronic display device, such as electronic display devices 112, 114, 116, and 118, via a local connection. By way of non-limiting example, electronic display devices 112, 114, 116, and 118 may contain one or more interfaces including, a USB (Universal Serial Bus) connection, an RS-232 or serial connection, a Bluetooth connection, a firewire connection, or interfaces supporting storage media (e.g., flash memory cards, CDs, DVDs). Electronic content may be received by an end user on electronic storage media and may be loaded onto or accessed by an electronic display device via one or more interfaces.

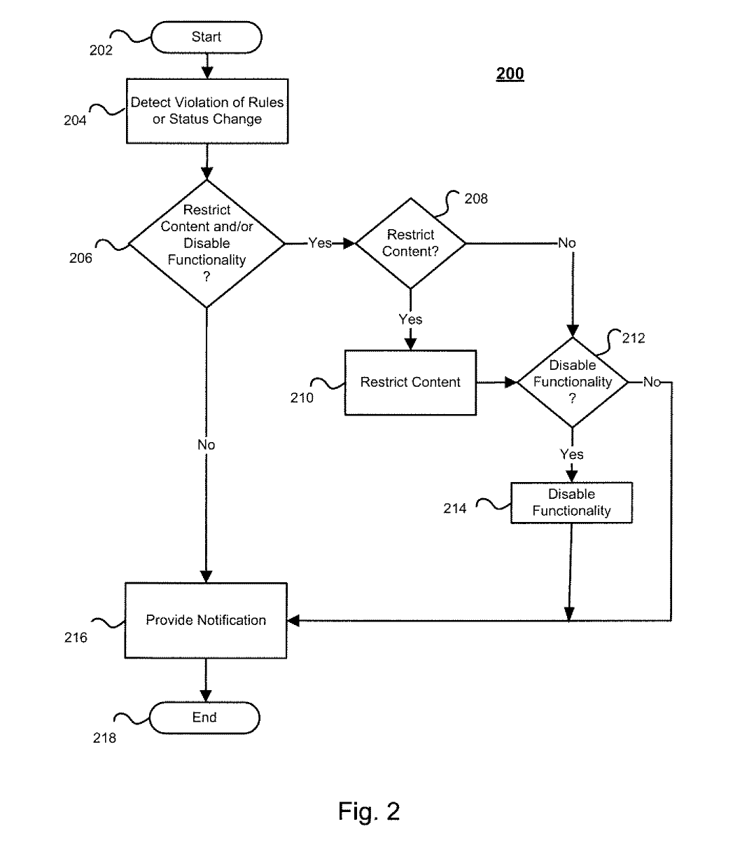

FIG. 2 is a flow chart illustrating method 200 for managing access to electronic content according to an embodiment of the present invention. At block 202, the method 200 for managing access to electronic content, in accordance with an exemplary embodiment, may begin.

At block 204, the method 200 may detect a violation of rules or an status change. By way of non-limiting example, the rules violation may be associated with an electronic content access agreement, an electronic content distribution agreement, an electronic content use agreement, an electronic display device use agreement, a federal law, a state law, a local law, or agreements associated with an electronic content distribution network or an electronic display device. The method 200 may also detect a status change associated with user or device access to electronic content. By way of non-limiting example, the status change may be the expiration of a user's subscription, the expiration of a group subscription, the termination of a subscription, the expiration of electronic content, or other events associated with a user's, distributor's, or content provider's right to electronic content.

At block 206, the method 200 may determine whether or not to perform one or both of restricting access to electronic content and disabling functionality of an electronic display device. The determination may be based on one or more specified factors and may use logic and components of a content distribution network and an electronic display device. By way of non-limiting example, events may include an unauthorized access attempt, an attempt by an unsubscribed user to access content requiring a subscription, an attempt to bypass an encryption mechanism, an attempt to bypass a password mechanism, an attempt to use the subscription of a different user, installation of unauthorized software, use of unauthorized software, an attempt to bypass an authentication mechanism, and exceeding a specified usage threshold.

Exceeding a specified usage threshold may include one or more of accessing a specified amount of data, using a specified bandwidth, connecting for a specified connection time, and meeting or exceeding a specified usage time. In one or more embodiments, groups accounts may be allowed access as measured by one or more of a maximum specified number of users, a maximum amount of bandwidth, and a specified amount of downloads or accesses. Counts of network addresses, domains associated with content access or requests may be monitored. Bandwidth usage associated with credentials, downloads associated with credentials, connection time associated with credentials or other factors may be evaluated.

Access may be restricted due to the detection of unauthorized software. Unauthorized software may include one or more of a packet sniffer, a vulnerability scanner, a port scanner, a worm, a virus, a trojan horse, a root kit, a password cracker, software designed to bypass or break digital rights management controls, or other unauthorized access tools and malware. In one or more embodiments, unauthorized software may be unsupported software, such as by way of non-limiting example, unsupported, outdated or unpatched operating systems, applications, pre-release software, or other platform software which may not support security or functionality desired by an electronic content provider, an electronic content distributor, or an electronic display device provider.

Other factors utilized to determine whether to disable one or both of electronic content access and device functionality may include indicators of inappropriate access. According to one or more embodiments, an electronic content access management mechanism, such as network element 110, may match any, or a combination, of usage, access, and attempted access of electronic content to one or more indicators in addition to account identifiers such as credentials, a username, and a password. For example, an electronic content access management mechanism may match a username or credential set with one or more device characteristics such as a network address, a MAC (Media Access Control) address, a device type, or other indicators which may be used to uniquely identify an electronic display device. In one or more embodiments, the detection of a set of credentials, or other access mechanisms, being used from a plurality of end user devices, may indicate an access violation. In another example, the detection of concurrent access from a plurality of end user devices by a single account may indicate an access violation.

One or more embodiments of an electronic display device may implement biometric security features. For example, an electronic display device may contain a mechanism for performing fingerprint recognition, retina recognition, or iris recognition. Verification of biometric security features may allow access to electronic content. Failure of biometric verification may indicate an access violation.

Other detected events which may be evaluated may include a usage pattern indicating impermissible use, such as by way of non-limiting example, a usage pattern indicating non-human reading of electronic content, access of electronic content by a web crawler; access of electronic content by an automatic content indexer; and access of electronic content by a bot. According to some embodiments, a sampling or distribution of reading rates for an electronic content type may be used. The reading rate of an electronic display device may be compared with a distribution of reading rates for an electronic content type or for the specific electronic content being read. If an electronic display device reading rate fails the comparison (e.g., the reading rate is outside of a standard deviation or exceeds a mean reading rate beyond a specified percentage) an access violation may be indicated. By way of non-limiting example, a speed of requests for display of a new page on a end user device may be measured. For example, a threshold speed may be specified for new page requests. Other patterns may be utilized.

According to some embodiments, a reverse Wring test may be used to verify that electronic content is being requested by a person and not a bot or an automated process. For example, a user of an electronic display device may be asked to enter text which is distorted in a manner that it remains readable by a person but not a machine (e.g., it may not be processed by an Optical Character Recognition system). In one or more embodiments, a user may also be asked to enter text contained in an image or a pattern that is discernable by a person but not a machine. Incorrect answers to a reverse turing test may indicate an access violation.

In one or more embodiments, one or more digital rights management technologies may be utilized to determine whether access should be restricted or functionality of an end user device disabled. Digital rights management may be utilized to prevent and detect attempts to perform any of a combination of copying, forwarding, sharing, printing electronic content, and performing other unauthorized uses of electronic content.

The determination, at block 206, of whether to disable access to electronic content or disable device functionality may be based at least in part on a determined severity of a violation. A severity of a violation may be determined by a specified severity level associated with the nature of event, the amount of data involved, the number of violations, or other factors. For example, an attempt to access content when a subscription has expired may be ranked at a different level than an attempt to bypass an encryption mechanism, or the installation of unauthorized software. An electronic content provider, an electronic content distributor, or another party, may specify responses to take corresponding to one or more detected events.

If restrictions to electronic content or disabling of end user device functionality is not to be performed, the method 200 may continue at block 216. If restrictions to electronic content access or disabling of end user device functionality is to be performed, the method 200 may continue at block 208.

At block 208, one or more factors may be evaluated to determine whether or not to restrict access to content. If access to content is to be restricted the method 200 may continue at block 210. If access to content is not to be restricted the method 200 may continue at block 212.

At block 210, access to content may be restricted. According to one or more embodiments, access to one or more content feeds may be restricted. For example, electronic content pushed to a user may be stopped by disabling one or more processes or by modifying a setting on a content distribution network. Access to content on a content distribution network may be restricted by one or more methods including, but not limited to, expiring credentials for a user, changing credentials, changing a key required for access, expiring a certificate, changing a password, setting a flag, modifying an ACL, and filtering access requests. In one or more embodiments, access may be disabled for a group subscription to one or more portions of electronic content requiring a subscription. The method 200 may continue at block 212.

At block 212, one or more factors may be evaluated to determine whether to disabled access to functionality of an end user device. If access to functionality is to be disabled, method 200 may continue at block 214. If access to functionality of an end user device is not to be disabled, the method 200 may continue at block 216.

At block 214, access to functionality of an end user device may be disabled. According to one or more embodiments, disabling access to an end user device, such as by way of non-limiting example electronic display devices 112, 114, 116, and 118, may include disabling a power supply of a user device. As described in further detail in reference to FIG. 4 below, one or more power components may be disabled rendering an end user device inoperable or rendering a battery of an end user device inoperable.

According to one or more embodiments, disabling access may include disabling a decryption mechanism of an end user device. Electronic content stored on an end user device or received by an end user device may be encrypted and disabling a decryption mechanism of an end user device may prevent access to electronic content.

Disabling an end user device may involve removing one or more software components of the end user device, according to one or more embodiments. By way of non-limiting example, software components removed may include one or more of operating system components, authentication software, digital certificates, credentials, and display control software.

At block 216, a notification may be provided to a user of a electronic display device, an account holder, or another party associated with the electronic display device or the electronic content access account. One or more different notifications may be provided based upon factors including, but not limited to, whether access to electronic content was restricted, whether functionality of an end user device was disabled, whether the notification is intended to be a warning prior to further action by a electronic content provider, or other factors. For example, if at block 206, a determination was made not to restrict access to content or end user device functionality at this time, the notification may be a warning. The warning may contain content associated with the event or status change detected in block 204. By way of non-limiting example, the warning may include payment information if an account is past due. The warning may provide a user with a payment method via the end user device, to restore access to one or more portions of electronic content. The payment method may include a URL to a payment system, a phone number for processing a phone payment, a postal address for mailing a payment, or other payment options. Warnings may include a scheduled termination date on which service may be terminated if a user does not respond (e.g., pay an account balance). Warnings associated with rules violations may include by way of non-limiting example a notification reminding a user of applicable rules and a notification requiring a user to cease the rule violations.

According to one or more embodiments, notifications may be marketing notifications. For example, if a user has terminated their subscription a renewal notification may be sent. Other notifications, by way of non-limiting example, may include: an offer to purchase increased bandwidth if current usage is exceeding a bandwidth limitation; an offer to purchase further licenses if a number of licensed users is exceeded for a group account; an offer to purchase additional subscriptions if an access attempt to unsubscribed content is detected; or other purchase offers. According to one or more embodiments, a notification may request a user to contact a service number.

If access to content has been restricted or functionality of an end-user device has been disabled, the notification may provide information associated with the restriction or the disablement. By way of non-limiting example, the notification may inform a user that device functionality has been disabled because of non-payment of an account balance. Other notifications are possible. In one or more embodiments, an end user device may utilize a display, such as an EPD, which is persistent (i.e., state bistable). Such as display may retain its displayed image in the absence of power. Thus a notification may remain on the display of an end user device even if the power supply of an end user device is disabled.

At block 218, the method 200 may end.

FIG. 3A is a schematic diagram of a display controller 305 in an electronic book 300 according to an embodiment of the present invention. An exemplary such display may be an EPD such as the EPD disclosed in U.S. patent application Ser. No. 12/497,199 entitled “Electronic Display Controller,” filed Jul. 2, 2009, the contents of which are hereby incorporated by reference in its entirety. Other embodiments may use an LCD (Liquid Crystal Display) based display, an LEP (Light Emitting Polymer) based display, a OLED (Organic Light Emitting Diode) based display, or other display technologies. Display controller 305 may be an integrated component of Soc 315. Display controller 305 may be utilized to disable the display of electronic content. Display controller 305 may access display 310 via SoC 315. Display 310 displays content in accordance with the system of electronic book 300. Display controller 305 may also be coupled to touch screen component 340 via SoC 315, which may be coextensive with display 310. That is, display 310 may include touch screen capabilities by way of incorporation of touch screen 340. Display controller 305 may further be coupled to external memory 320 and 325 via SoC 315. External memory 320 may be, by way of non-limiting example, an SDRAM integrated circuit. Display controller 305 may be further coupled, via SoC 315, to a sub-system that allows electronic book 300 to send and receive data, such as book, magazine and newspaper content. According to some embodiments, secure IC 350 may be a component of or integrated with SoC 315. Secure IC 350 may receive encryption keys, unscramble data, and perform other security related measures. Secure IC 350 may communicate with an authentication server or an authorization server such as authorization server 122 of FIG. 1. The subsystem includes evolution data optimized (“EVDO”) modem 330, which itself may be coupled to antenna 345 and to a system-on-chip (“SoC”) application specific integrated circuit (“ASIC”) 315. SoC 315 acts as an intermediary between EVDO modem 330 and display controller 305. SoC 315 may be further coupled to external volatile memory 320 (e.g., an SDRAM integrated circuit), to external persistent memory 335 (e.g., a flash memory integrated circuit), and optional external persistent memory 337 (e.g., removable storage media, a flash memory card). An external temperature sensor (not shown) may be coupled to display controller 305 via SoC 315.

Embodiments of the present invention may include further power management features. Such power management features may be utilized to disable a display when a rules violation or other event is detected by the display's host device. For example, a host device may detect a rules violation or may be notified of a host violation via data received from an electronic content provider or an electronic content distributor. The notification may be received via EVDO modem 330. Accordingly, the display controller may set a bit to signal to its host that the display is to be disabled. At that point, all power to the display may be suspended, e.g., by the display controller.

The display controller may enter any of a variety of low-power or no-power modes. As one example, the display controller may halt access to memory (e.g., memory 320), cutting power to an associated controller (e.g., a DDR (Double-Data-Rate) controller associated with memory 320). As another example, memory (e.g., memory 320) may be set to self-refresh mode (e.g., cutting V_{TT} and V_{DD}). In one embodiment, V_{TT} and V_{DD} may be used during any, or a combination, of normal read and write operations in a memory device (e.g., a Double-Data-Rate Synchronous Dynamic Random Access Memory (DDR SDRAM)). For example, V_{TT} may be associated with a Input/Output termination voltage of a memory device and V_{DD} may be associated with a device supply voltage of a memory device.

An alternate or additional power saving feature in which the host CPU may be turned off is described presently. Before a display controller completes a frame update, but after image information is read, the display controller may signal that it has completed receiving such data. The host CPU may shut down in response to such signal. In the alternative, the display controller may use hardware or software to initiate a suspend mode by itself and a complex programmable logic device (“CPLD”) that operates as a power controller. Suspend mode may be initiated and terminated by either hardware or software. Exemplary suspend sequences for both are discussed below.

An exemplary hardware suspend mode entrance sequence is described presently. The host first sets indicator bits that respectively indicate that the display power is to be automatically shut off (e.g., set Panel_pwr_auto_off=1) and that hardware is suspending the display controller (e.g., set HW_suspend=1). The display controller then polls to determine whether any pending update is complete (e.g., poll to determine whether Update_Done=1). If the poll indicates that all pending updates are complete, the host proceeds to disable the display. Internal to the display controller, if a suspend indicator bit is set to zero, then display controller hardware checks whether a suspend request signal is present from the CPLD (e.g., determine whether Suspend_Req=1). If so, the suspend sequence is initiated. Hardware clears any bit indicating that the display controller's memory is ready (e.g., set DRAM_ready=0). Hardware puts the memory interface (e.g., a DDR controller associated with memory 320) in self-refresh mode (e.g., by asserting a DDR_SR signal). Hardware then asserts the display controller's “Suspended” pin, which is connected to the CPLD, indicating that the display controller is in suspend mode. The CPLD deasserts the chip enabled bit (e.g., sets Chip_EN=0) to gate-off all display controller clocks glitch-free, disables a phase locked loop (“PLL”) associated with the display controller, and disables all outputs. The CPLD may also turn off the display controller's input/output power.

An exemplary hardware suspend mode exit sequence is described presently. In one or more embodiments, if device functionality is to be re-enabled (e.g., account payment is received) a hardware suspend mode exit sequence may be utilized. The CPLD turns on the display controller's input/output power. Next, the CPLD asserts a chip enabled pin (e.g., sets Chip_EN=1) to start the PLL. When a PLL lock pin is set (e.g., PLL_lock=1), hardware turns on the display controller's clocks glitch-free. If the suspend request bit is set to negative (e.g., Suspend_Req=0), the suspend bit is set to positive (e.g., Suspended=1), and the chip enable bit is set to positive (e.g., Chip_EN=1), then the display controller proceeds to exit suspend mode. Hardware exits the memory's self-refresh mode by deasserting the self-refresh bit (e.g., setting DDR_SR=0). Hardware then sets the controller's memory's ready bit to positive (e.g., set DRAM_ready bit=1) and deasserts the Suspend signal (e.g., sets Suspend=0).

An exemplary software suspend mode entrance sequence is described presently. The host sets a bit that indicates that the display is about to initiate an auto-off sequence (e.g., set Panel_pwr_auto_off=1) and sets a bit that indicates that the suspend mode is not hardware-initiated (e.g., set HW_suspend=0). The display controller then polls to determine whether any pending update is complete (e.g., poll to determine whether Update_Done=1). If the poll indicates that all pending updates are complete, then a bit indicating that the display controller is in suspend mode is set (e.g., set Stdby=1). The suspend bit is next polled to determine whether the display controller is already in suspend mode (e.g., poll whether Suspended=0). If not, a software suspend request bit is set (e.g., set SW_susp_req=1). (Note that hardware may clear a memory ready bit once the DDR is in self-refresh mode). The suspend bit is set to positive (e.g., set Suspended=1). A chip-enabled bit is set to negative (e.g., set Chip_EN=0) to gate off all display controller clocks glitch-free. The PLL is disabled, as are all outputs. The host can also turn off the display controller's input/output power (e.g., by setting Vtt_EN=0).

An exemplary software suspend mode exit sequence is described presently. In one or more embodiments, if device functionality is to be re-enabled (e.g., account payment is received) a software suspend mode exit sequence may be utilized. The host turns on the display controller's input/output power (e.g., set Vtt_EN=1). The host asserts a chip-enable bit (e.g., set Chip_EN=1) to start a PLL. The process may pause to allow the PLL to lock (e.g., twenty milliseconds). The suspend request bit is set to negative (e.g., set SW_susp_req=0). Once a poll of the memory ready bit indicates the memory is ready (e.g., DRAM_ready=1), the suspend bit is set to negative (e.g., set Suspend=0).

Certain embodiments of the present invention provide a display controller with embedded security protection. In such embodiments, rather than requiring the host to authenticate and encrypt image data, the display controller performs this role. Having a display controller contain embedded security functionality may reduce vulnerability by reducing a chance that a security mechanism may be bypassed. Embedded security functionality may prevent exposure of vulnerable communication paths between security circuitry and display circuitry by reducing the communication path to one or more circuit traces. Accordingly, the display controller may include logic that is configured to perform various security functions (e.g., authentication functions) and logic that is configured to disable one or more portions of the display controller (e.g., disable the clock to disable the entire display controller) in the event of a security trigger (e.g., authentication failure). In one embodiment, a security trigger may allow for one or more portions of the display controller to remain enabled such that the display controller displays a warning message about unauthorized content, a message about a deactivated service, contact information to re-establish service, or a similar notice. Messages may also be conveyed via an LED (e.g., a flashing red LED may indicate a disabled system), a recorded or generated message played via a speaker, or by another user interface.

FIG. 3B is a schematic diagram of an electronic display device according to an alternate embodiment of the present invention. As illustrated in FIG. 3B, electronic book 310 may contain many of the same components of electronic book 300. Electronic book 310 may however contain SoC 344 and display controller 346. SoC 344 may perform substantially the same functionality as SoC 315, but may not contain an integrated display controller. SoC 344 may interface or couple with display controller 346. Display controller 346 may perform substantially the same functionality as display controller 305, but may not be an integrated component of Soc 344. Display controller 346 may interface directly with one or more components, such as, volatile memory 325. touch screen 340, display 310, and smart card 342. Soc 344 may also integrate with Secure IC 352. Secure IC 352 may perform substantially the same functionality as secure IC 350, but may not be an integrated component of SoC 344.

FIG. 4 is a schematic diagram of a power supply path for an electronic display device according to an embodiment of the present invention. System-on-chip (“SoC”) application specific integrated circuit (“ASIC”) 315 may be coupled to power supply 405 and charger 415. Power supply 405 and charger 415 may be coupled to power adapter 410 which may in turn be coupled to mains (e.g., AC line power). Charger 415 may be coupled to battery 420.

According to one or more embodiments, if Soc 315 may detect an event or receive a communication via EVDO modem 330, requesting disablement of an end-user device. Soc 315 may interface with power supply 405 to perform one or more power management functions. For example, Soc 315 may utilize one or more power management features of power supply 405 to disable power to a display, to one or more interfaces or peripherals or to volatile memory 320.

According to one or more embodiments, upon receiving a communication or detecting one or more events (e.g., the receipt of a unexpired digital certificate), Soc 315 may utilize one or more power management features of power supply 405 to enable power to a display, to one or more interfaces or peripherals or to volatile memory 320.

According to one or more embodiments, Soc 315 may utilize one or more power management features of power supply 405 to limit functionality or partially disable functionality of an end user device. For example, Soc 315 may disable power to charger 415 which may result in battery 420 being drained and may limit the mobility of an end user device. Soc 315 may disable power to other components, such as non-volatile memory 335, which may prevent access to stored electronic content.

Other embodiments, uses, and advantages of the present invention will be apparent to those skilled in the art from consideration of the specification and practice of the present invention disclosed herein. The specification and drawings should be considered exemplary only, and the scope of the present invention is accordingly intended to be limited only by the following claims and equivalents thereof.

We claim:

1. A hardware implemented method for managing electronic content access, the method comprising:
detecting, at an electronic paper display device, an event requiring electronic content access management; and
disabling access to one or more portions of electronic content for a user of the electronic paper display device based at least in part on the event.

2. The hardware implemented method of claim 1, wherein the event comprises a termination of a subscription to electronic content.

3. The hardware implemented method of claim 1, wherein the event comprises an unauthorized access attempt.

4. The hardware implemented method of claim 3, wherein the unauthorized access attempt comprises at least one of: an attempt by an unsubscribed user to access content requiring a subscription, an attempt to bypass an encryption mechanism, an attempt to bypass a password mechanism, an attempt to use the subscription of a different user, installation of unauthorized software, use of unauthorized software, and an attempt to bypass an authentication mechanism.

5. The hardware implemented method of claim 1, wherein the event comprises exceeding a specified usage threshold.

6. The hardware implemented method of claim 5, wherein the specified usage threshold comprises at least one of: a specified amount of data, a specified bandwidth, a specified connection time, and a specified usage time.

7. The hardware implemented method of claim 1, wherein the event comprises a usage pattern indicating impermissible use.

8. The hardware implemented method of claim 7, wherein the usage pattern indicates at least one of: non-human reading, a web crawler, an automatic content indexer, and a bot.

9. The hardware implemented method of claim 1, wherein the event comprises a electronic content usage violation.

10. The hardware implemented method of claim 1, wherein disabling access comprises stopping access to one or more content feeds.

11. The hardware implemented method of claim 1, wherein disabling access comprises preventing network access.

12. The hardware implemented method of claim 1, wherein disabling access comprises disabling functionality of the content reader device.

13. The hardware implemented method of claim 1, wherein disabling access comprises disabling a power supply of the content reader device.

14. The hardware implemented method of claim 1, wherein disabling access comprises disabling a decryption mechanism.

15. The hardware implemented method of claim 1, wherein disabling access comprises stopping access, for a group subscription, to one or more portions of electronic content requiring a subscription.

16. The hardware implemented method of claim 1, further comprising:
sending a notification to the user prior to disabling access to one or more portions of electronic content.

17. The hardware implemented method of claim 1, further comprising:
providing a user with a payment method, via the content reader device, to restore access to one or more portions of electronic content.

18. A system for managing electronic content access comprising:
one or more processors communicatively coupled to a network, wherein the one or more processors are configured to:
receive a signal, at an electronic paper display device, indicating violation of an electronic paper display device usage agreement; and
disable access to one or more portions of electronic content for a user of the electronic paper display device based at least in part on the event.

19. An electronic paper display device comprising:
a persistent display for displaying electronic content;
a communications module for receiving electronic content; and
a processor communicatively coupled to the display and the communications module, wherein the processor is configured to:
detect an event comprising a violation of an electronic paper display device usage rule; and
provide a notification to a user of the electronic paper display device based at least in part on the detection of the event.

20. The electronic paper display device of claim 19 wherein the processor is further configured to:
disable one or more portions of electronic paper display device functionality based at least in part on detection of the event.
